(19) United States
(12) Patent Application Publication
(10) Pub. No.: US 2016/0146444 A1
(43) Pub. Date: May 26, 2016

(54) LED HOLDER SYSTEM

(71) Applicants: Gregory P. MEYER, Lisle, IL (US); Michael C. PICINI, Lisle, IL (US); MOLEX INCORPORATED, Lisle, IL (US)

(72) Inventors: Gregory P. Meyer, Elk Grove Village, IL (US); Michael C. Picini, Aurora, IL (US)

(73) Assignee: MOLEX INCORPORATED, Lisle, IL (US)

(21) Appl. No.: 14/900,971

(22) PCT Filed: Jun. 30, 2014
(86) PCT No.: PCT/US14/44792

§ 371 Date: Dec. 22, 2015

Related U.S. Application Data
(60) Provisional application No. 61/842,123, filed on Jul. 2, 2013.

(51) Int. Cl. F21V 23/06; F21V 29/70; F21V 19/00

(52) U.S. Cl. CPC F21V 23/06; F21V 19/0035; F21V 29/70; F21Y 2101/02

(57) ABSTRACT

A holder is provided to hold an LED array and the holder includes an LED aperture. The holder includes terminals that are stitched into the holder. The terminals can be heat staked to the holder. The holder can include a mating area.

### RELATED APPLICATIONS

This application claims priority to U.S. Provisional Application No. 61/842,123, filed Jul. 2, 2013, which is incorporated herein by reference in its entirety.

### FIELD OF THE INVENTION

The present invention relates to field of solid state lighting (SSL), more specifically to SSL applications using light emitting diode (LED) arrays.

### DESCRIPTION OF RELATED ART

LED holders are known and have become more popular due to the benefits of easing use of LED arrays.

### BRIEF SUMMARY

A holder includes a top surface and an aperture that allow light to extend through the holder. The holder has an integral connector recessed into a top surface. Two terminals are stitched into the integral connector and provide a connection between the integral connector and contacts that extend under the housing. The terminals can be held in place with a heat staking operation if desired.

### BRIEF DESCRIPTION OF THE DRAWINGS

The present invention is illustrated by way of example and not limited in the accompanying figures in which like reference numerals indicate similar elements and in which:

FIG. 1A illustrates a perspective view of an embodiment of a LED holder system.

FIG. 1B illustrates a perspective view of another embodiment of a LED holder system.

FIG. 2 illustrates another perspective view of the embodiment depicted in FIG. 1B.

FIG. 3A illustrates a perspective view of a holder being assembled to an LED array.

FIG. 3B illustrates a perspective view of another holder being assembled to an LED array.

FIG. 4 illustrates an exploded view of an embodiment of a LED holder system.

FIG. 5 illustrates a perspective view of an embodiment of a holder.

FIG. 6 illustrates a perspective view of an embodiment of a mating area.

FIG. 7 illustrates a perspective view of the mating area of FIG. 6 with the terminals removed.

FIG. 8 illustrates a perspective view of a bottom of a holder with the terminal removed.

FIG. 9 illustrates a perspective view of a bottom view of a holder with a terminal inserted into the holder.

FIG. 10 illustrates a perspective view of the embodiment depicted in FIG. 9 with a lip formed.

FIG. 11 illustrates a perspective view of another embodiment of a bottom of a LED holder.

### DETAILED DESCRIPTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

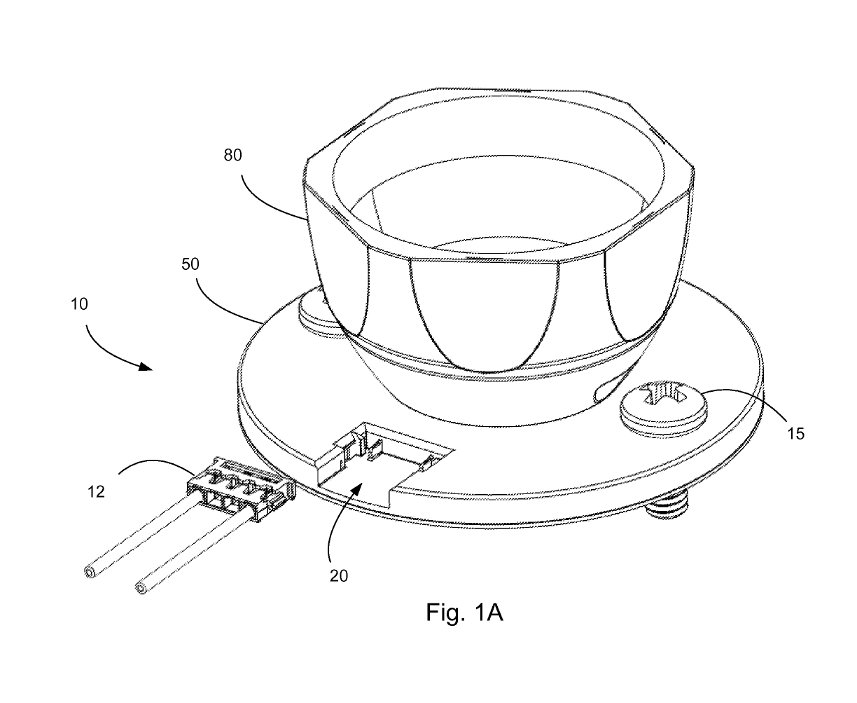

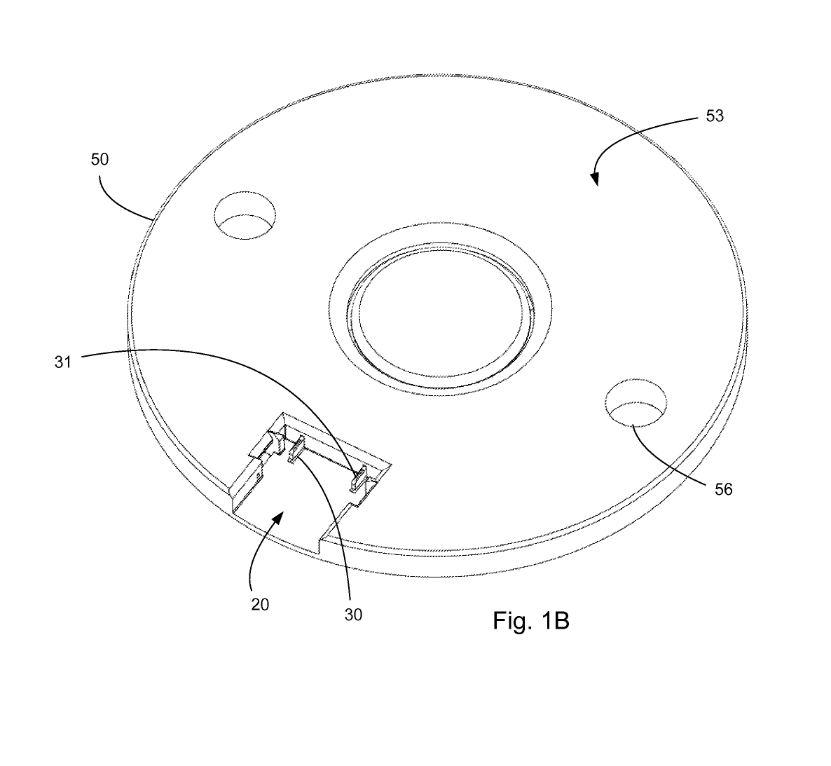

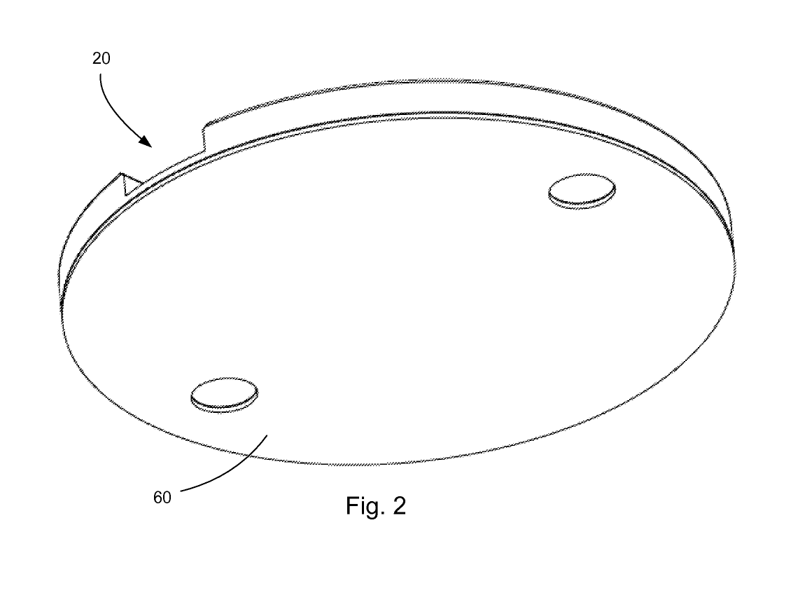

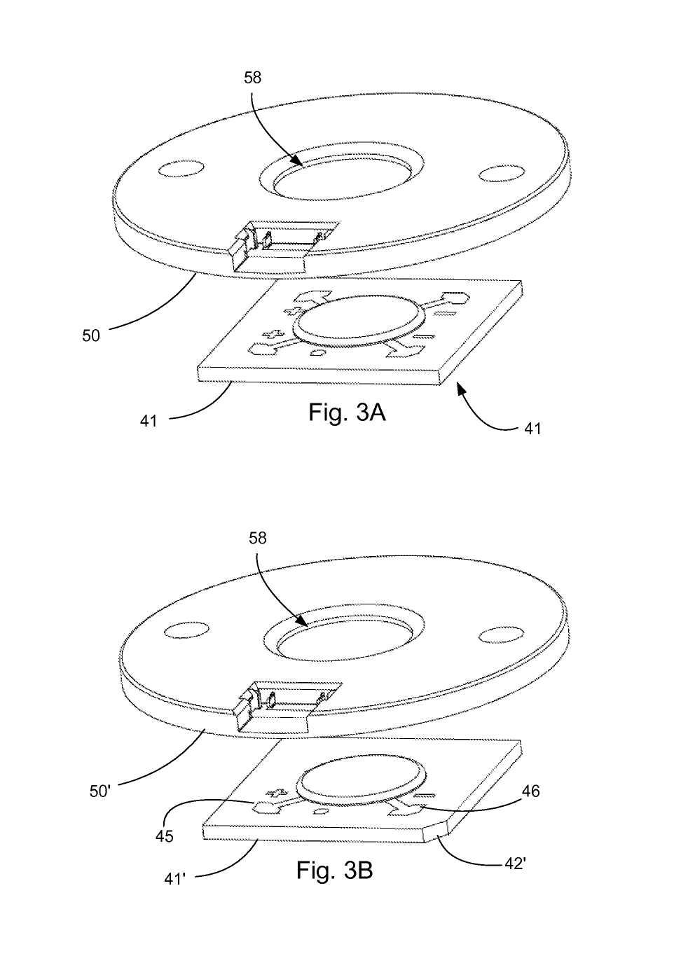

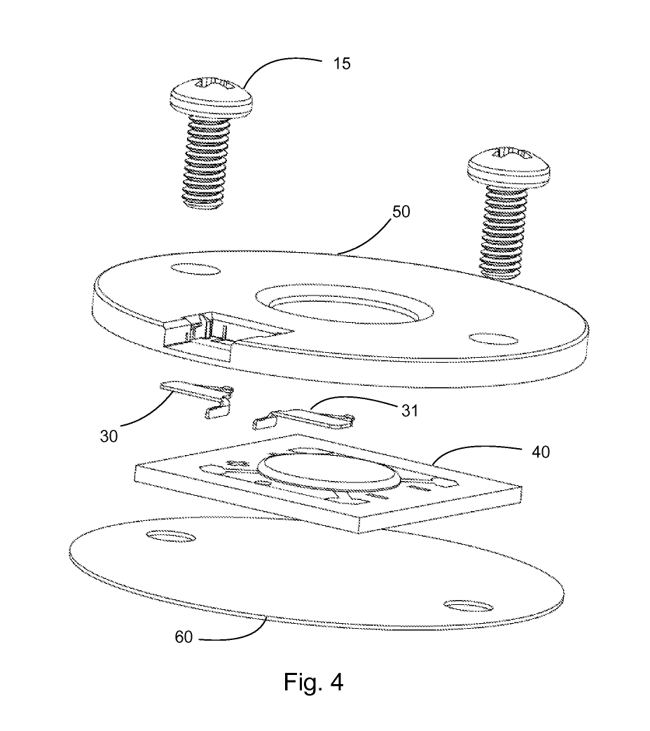

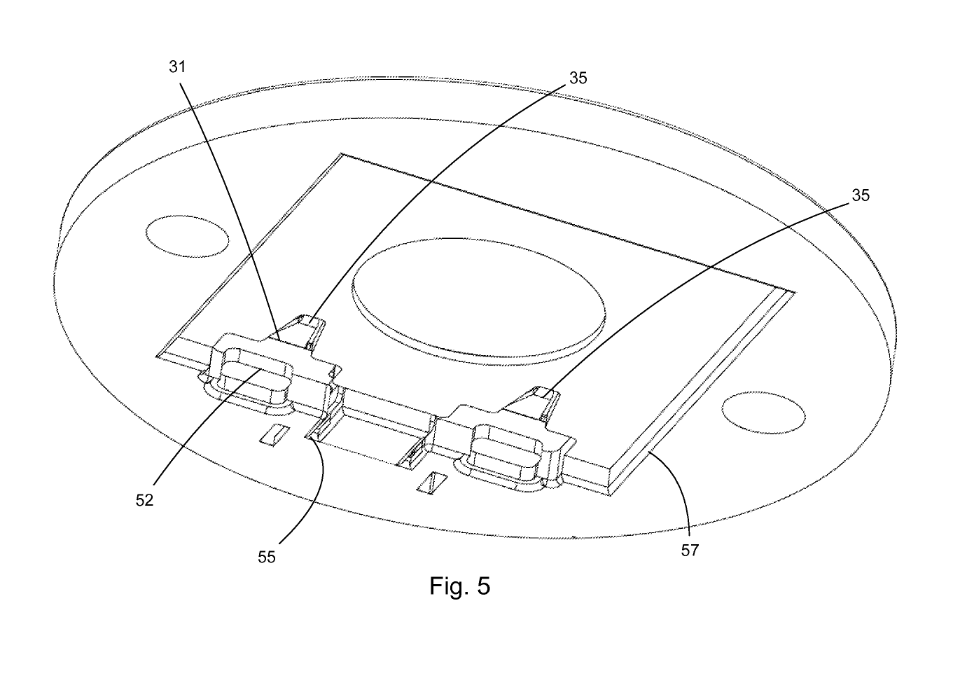

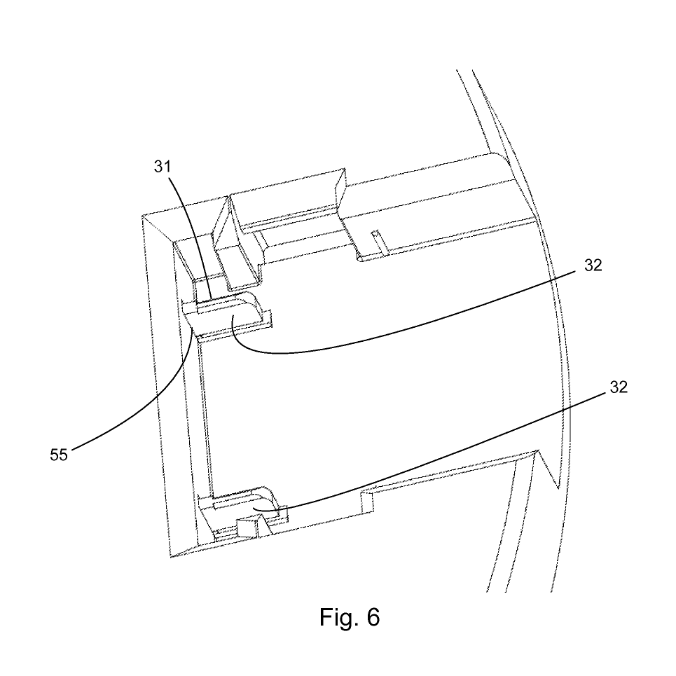

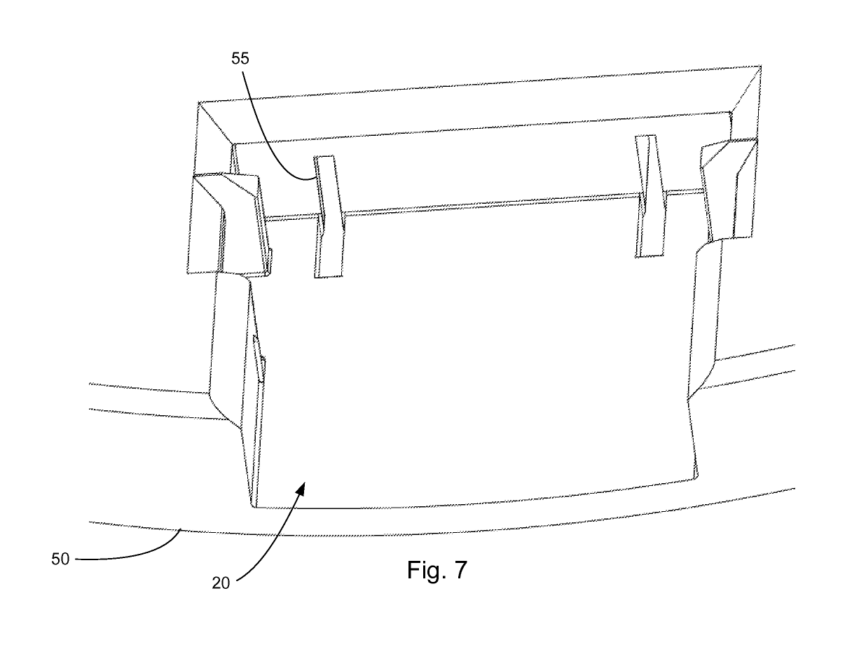

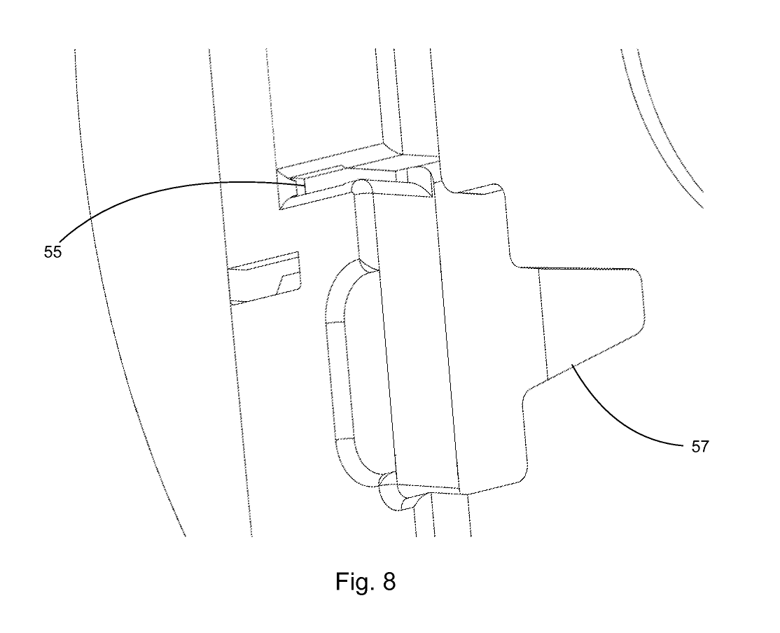

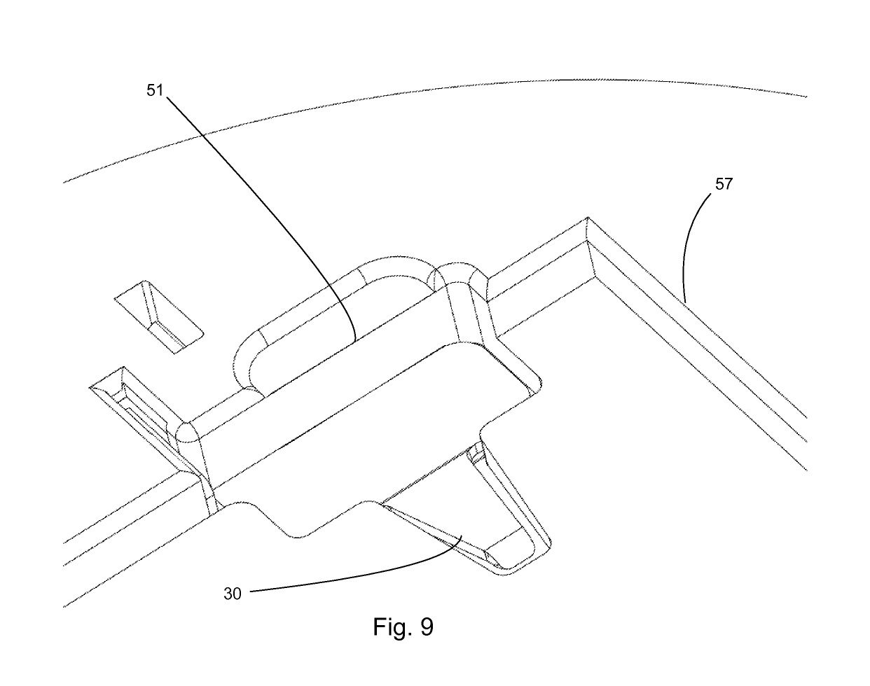

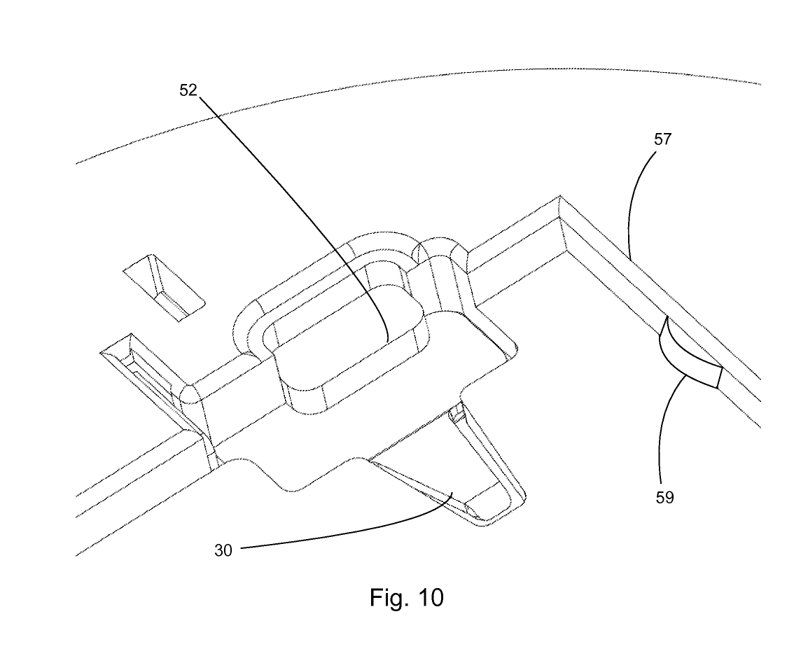

FIGS. 1A-11 illustrate embodiments that can be used in a LED holder system. A holder 10 includes a housing 50 with a top surface 53 that has a light aperture 58 and the housing 50 can be mounted to a heat sink with one or more fasteners 15 positioned in retaining apertures 56. A thermal pad 60 can be provided to help improve transfer of thermal energy between the LED array and a supporting surface. It should be noted that the type of fastener can be varied as a wide variety of fasteners would be suitable and the use of a retaining aperture 56 (and a fastener) is optional as edges of the housing 50 could be used to secure the LED holder in position. As can be appreciated, a light shaping element 80 (which can be a reflector or some sort of lens or a cover or combination thereof) can be optionally included with the holder 10. The light shaping element 80 can be adhered to the housing 50 or it can be attached with snaps, clips or other desirable retention features. A connector assembly 12 can mate to the mating area 20.

The housing 50 provides a mating area 20 that is configured to receive a mating connector. The mating area 20 includes two terminal apertures 55 that extend from the mating area 20 to a terminal recess 57. The terminal apertures 55, to provide improved electrical isolation, can be fully contained within the housing 50 rather than being an open ended slot.

Terminals 30, 31 are inserted into the two terminal apertures 55 and can be retained in the terminal recess 57 with an adhesive, heat staking or if the housing 50 is suitable, with an interference fit between the terminals 30, 31 and the housing 50. The terminals 30, 31 each include a contact 32 that is positioned in the mating area 20 and include a tail 35 that is configured to engage top-facing set of contacts of an LED array. The tail can be configured to be compressed against a top surface so as to ensure good electrical connection between the terminal and the top-facing contacts on the LED array. The holder 10 is thus configured to mount on a LED array 40 that has a top-facing set of contacts 45, 46 on a substrate 41. Common examples of such LED arrays are known as chip-on-board (COB) LEDs. Substrate 41′ is an alternative embodiment with a truncated shoulder 42′. The terminals inserted into the mating area provide an integrated connector in the holder.

As can be, the depicted embodiment does not have to have an insert-molding operation and can use simpler manufacturing processes. In addition, another benefit is that there is no need to hold the terminal in place with pins as the housing is being formed, thus the depicted design avoids the need for extra holes in the housing that could provide a problem for creepage and clearance.

If the terminals 30, 31 are to be retained by a heat staking operation, a lip 52 can be formed during a heat staking operation that deforms wall 51 into the lip 52. Thus, the depicted embodiment illustrates a heat stake lip. The size of the lip 52 can vary as desired.

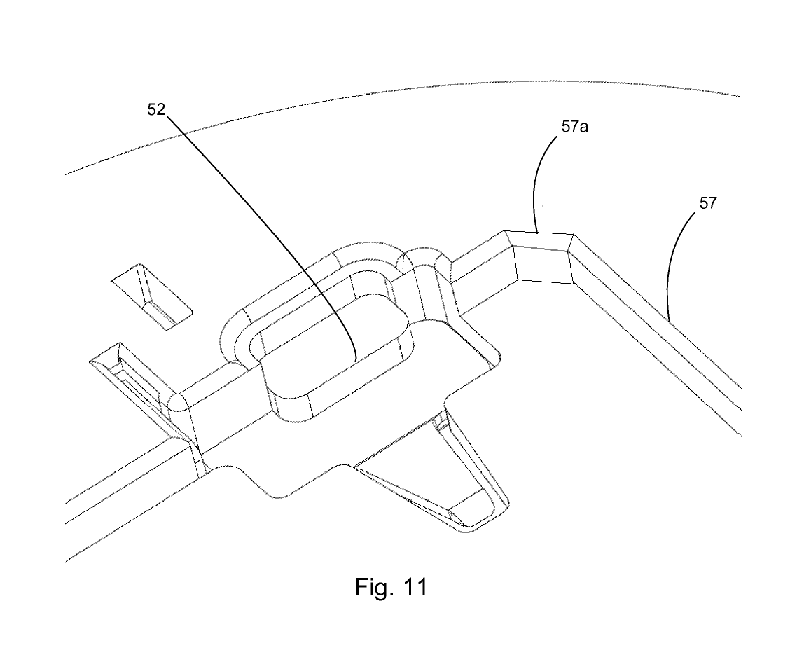

The housing 50 includes a substrate recess 57 that receives the LED array 40 and the tails 45 are aligned with pads 45, 46 on the LED array. To help align the LED array, one or more alignment features 57a can be included in the substrate recess 57. For example, as depicted in FIG. 11, a truncated corner of holder 50′ is the alignment feature 57a and corresponds to the truncated shoulder 42′ on the corresponding LED array and helps ensure that the LED array can only be mated in one orientation.

It should be noted that the housing 50 does not have to be coupled to the LED array in the depicted embodiment and instead can be placed over the LED array when it is desirable to mount the LED array in position. In an embodiment, a retention member, such as retention bump 59, could engage a side of the LED array so as to secure the LED array to the housing 50 with an interference fit. In another embodiment, the retention member could be a feature such as a finger or other similar shape that could be used to engage a mating feature on the LED array so that the LED could be secured to the housing. In either case, the ability to securely mount the holder assembly 10 to a supporting surface would help ensure a reliable electrical connection between the integral connector and the COB LED. In other words, the retention member does not need to ensure a good electrical connection is made between pads on a mating LED array and the terminal tails

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. A light emitting diode (LED) holder, comprising:
a housing having a substrate recess, an internal aperture, a mating area, first and second terminal recesses and a first terminal aperture extending between the mating area and the first terminal recess and a second terminal aperture extending between the mating area and the second terminal recess;
a first terminal with a first contact and a first tail, the first contact positioned in mating area and aligned with the first terminal aperture; and
a second terminal with a second contact and a second tail, the second contact positioned in mating area and aligned with the second terminal aperture.

2. The LED holder of claim 1, wherein the terminal apertures are fully contained within the housing.

3. The LED holder of claim 1, wherein the terminals are retained in the housing with a heat staked lip.

4. The LED holder of claim 1, further comprising a light shaping element mounted on a top surface of the housing.

5. The LED holder of claim 1, wherein the substrate recess includes a retention member.
